(19) United States
(12) Patent Application Publication
(10) Pub. No.: US 2026/0341966 A1
(43) Pub. Date: Oct. 29, 2026

(54) FREQUENCY SELECTIVE SURFACE STRUCTURE AND ANTENNA APPARATUS

(71) Applicant: TP-Link Systems Inc., IRVINE, CA (US)

(72) Inventors: Yuxiu YANG, Shenzhen (CN); Jinwei SHAO, Shenzhen (CN)

(73) Assignee: TP-Link Systems Inc., IRVINE, CA (US)

(21) Appl. No.: 19/190,541

(22) Filed: Apr. 25, 2025

(51) Int. Cl. H01Q 15/00

(52) U.S. Cl. CPC H01Q 15/0066

(57) ABSTRACT

A frequency selective surface (FSS) structure is provided. The FSS structure includes at least two FSS units. Each FSS unit includes a substrate, a first metal sheet and a second metal sheet, the second metal sheet surrounding the first metal sheet with a gap therebetween. Substrates of the at least two FSS units are in contact with each other. At least one switch element is provided on the second metal sheet. The second metal sheets of the at least two FSS units are not in contact with each other.

### TECHNICAL FIELD

The present disclosure relates to antenna field, in particular to a frequency selective surface (FSS) structure and an antenna apparatus comprising the FSS structure.

### BACKGROUND

A metasurface structure has attracted extensive attention in a radio frequency (RF) microwave field, especially in the antenna field, because of its electromagnetic characteristics that natural materials do not have. The radiation pattern of the antenna apparatus comprising the metasurface structure can be controlled by changing the operation state of the metasurface structure.

The frequency selective surface (FSS) is a metasurface structure with a periodic arrangement of the FSS units, which has a characteristic of frequency selection for electromagnetic waves in the spatial domain and can effectively control the frequency response characteristics of the electromagnetic waves.

### SUMMARY

Based on the above, the present disclosure provides an FSS structure, an antenna apparatus comprising the FSS structure and a method for controlling the antenna apparatus.

In an aspect of the present disclosure, the present disclosure provides a frequency selective surface (FSS) structure, comprising: at least two FSS units, wherein each FSS unit comprises a substrate, a first metal sheet and a second metal sheet, the second metal sheet surrounding the first metal sheet with a gap therebetween, wherein substrates of the at least two FSS units are in contact with each other, wherein at least one switch element is provided on the second metal sheet, and wherein the second metal sheets of the at least two FSS units are not in contact with each other.

In an aspect of the present disclosure, the present disclosure provides an antenna apparatus, comprising, an antenna, a frequency selective surface (FSS) structure, wherein the FSS structure comprises at least two FSS units, wherein each FSS unit comprises a substrate, a first metal sheet and a second metal sheet, the second metal sheet surrounding the first metal sheet with a gap therebetween, wherein substrates of the at least two FSS units are in contact with each other, wherein at least one switch element is provided on the second metal sheet, and wherein the second metal sheets of the at least two FSS units are not in contact with each other; and a control circuit, configured to control the at least one switch element of each FSS unit to be on or off based on a control signal.

In an aspect of the present disclosure, the present disclosure provides a method for controlling an antenna apparatus comprising an antenna, a FSS structure, and a control circuit, wherein the FSS structure comprises at least two FSS units, wherein each FSS unit comprises a substrate, a first metal sheet and a second metal sheet, the second metal sheet surrounding the first metal sheet with a gap therebetween, wherein substrates of the at least two FSS units are in contact with each other, wherein at least one switch element is provided on the second metal sheet, and wherein the second metal sheets of the at least two FSS units are not in contact with each other, the method comprising: controlling the at least one switch element of each FSS unit to be on or off based on a control signal.

The foregoing has outlined rather broadly the features and technical advantages of examples according to the disclosure. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims.

### BRIEF DESCRIPTION OF THE DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure, but do not constitute a limitation to the present disclosure. In the drawings, unless otherwise explicitly indicated, the same reference numerals refer to the same components, steps, or elements. In the accompanying drawings,

FIG. 1 shows the conventional FSS structure;

FIGS. 2A and 2B show examples of an FSS structure according to an embodiment of the present disclosure;

FIGS. 3A and 3B show example equivalent circuit diagrams of the FSS unit of the FSS structure shown in FIG. 2B;

FIG. 4 shows an example of an antenna apparatus according to an embodiment of the present disclosure;

FIG. 5 shows another example of an antenna apparatus according to an embodiment of the present disclosure;

FIG. 6 shows an example reflection coefficient of the antenna apparatus shown in FIG. 5 under different operation states of the FSS structure thereof;

FIGS. 7A-7D show example radiation patterns of the antenna apparatus shown in FIG. 5;

FIG. 8 shows another example of an antenna apparatus according to an embodiment of the present disclosure;

FIG. 9 shows a projection of the FSS structure of the antenna apparatus in FIG. 8 on a plane on which the antenna is located of the antenna apparatus;

FIGS. 10A-10I show example radiation patterns of the antenna apparatus shown in FIG. 8;

FIG. 11 shows another example of an antenna apparatus according to an embodiment of the present disclosure; and

FIGS. 12A-12F show example radiation patterns of the antenna apparatus shown in FIG. 11.

### DETAILED DESCRIPTION

The technical solution of the present disclosure will be clearly and completely described below in conjunction with accompanying drawings. Obviously, the described embodiments are part of embodiments of the present disclosure, but not all of them. Based on the embodiments in the present disclosure, all other embodiments obtained by ordinary skilled in the art without making any creative efforts fall within the scope of protection of the present disclosure.

In the description of the present disclosure, it should be noted that orientations or positional relationships indicated by terms such as “center”, “upper”, “lower”, “left”, “right”, “vertical”, “horizontal”, “inside” and “outside” are based on orientations or positional relationships shown in the drawings, only for the convenience of describing the present disclosure and simplifying the description, instead of indicating or implying the indicated device or element must have a particular orientation. In addition, terms such as “first”, “second” and “third” are only for descriptive purposes, whereas cannot be understood as indicating or implying relative importance. Likewise, words like “a”, “an” or “the” do not represent a quantity limit, but represent an existence of at least one. Words like “include” or “comprise” mean that an element or an object in front of the said word encompasses those ones listed following the said word and their equivalents, without excluding other elements or objects. Words like “connect” or “link” are not limited to physical or mechanical connections, but may include electrical connections, whether direct or indirect.

In the description of the present disclosure, it should be noted that, unless otherwise explicitly specified and limited, terms such as “mount”, “link” and “connect” should be understood in a broad sense. For example, such terms may refer to being fixedly connected, or detachably connected, or integrally connected; may refer to being mechanically connected, or electrically connected; may refer to being directly connected, or indirectly connected via an intermediate medium, or internally connected inside two elements. For ordinary skilled in the art, the specific meanings of the above terms in the present disclosure may be understood on a case-by-case basis.

In addition, technical features involved in different embodiments of the present disclosure described below may be combined with each other as long as no conflicts occurs therebetween. Further, figures are merely for illustration and are simplified for brevity and thus may be not exactly the same as practical implementations. For example, in figures, the processing delay of devices may be omitted.

In this disclosure, the frequency selective surface may refer to a structure with one or more FSS units, which may be used to control the propagation of an electromagnetic wave incidence to it by controlling operation states of the FSS structure. The FSS structure may be controlled to transmit, reflect or absorb the electromagnetic wave.

An antenna may refer to a kind of transducer, which transforms the guided wave propagating on the transmission line into an electromagnetic wave propagating in unbounded medium (usually a free space), or vice versa. The antenna may be used to transmit or receive electromagnetic waves in radio equipment. The antenna may be an omnidirectional antenna or a directional antenna. The antenna may be a single antenna, or an antenna array comprising a plurality of antenna elements.

An antenna apparatus may refer to an apparatus configured to radiate and receive the electromagnetic wave (such as the radio wave), which may comprise at least the antenna. Exemplarily, the antenna apparatus may be implemented as part of devices such as a user equipment (UE), or a network node in a communication system. The UE may comprise, for example, a mobile device, a mobile station, a terminal, a subscriber unit, a mobile phone, a cellular phone, a smart phone, a desktop computer, a laptop computer, a tablet computer, a gaming device, an internet-of-things (IoT) device and the like. The network node may comprise, for example, a NR base station, an LTE base station, a Node B, an eNB (e.g., in 4G), a gNB (e.g., in 5G), an access point (AP), a transmission and reception point (TRP) and the like.

FIG. 1 shows the conventional FSS structure 100. As shown in FIG. 1, the conventional FSS structure 100 may comprise multiple FSS units, for example, FSS units 120a, 120b, and 120c. Each FSS unit may comprise a substrate, a first metal sheet, a second metal sheet, and a switch element. The second metal sheet surrounds the first metal sheet with a gap therebetween. Substrates of the multiple FSS units are in contact with each other. The switch element is provided on the second metal sheet. For example, as shown in FIG. 1, the FSS unit 120a may comprise a substrate 120a-2, a first metal sheet 120a-4, a second metal sheet 120a-8, and a switch element 120a-10 provided on the second metal sheet 120a-8. The second metal sheet 120a-8 surrounds the first metal sheet 120a-4 with a gap 120a-6 therebetween.

The conventional FSS structure (such as the FSS structure 100 shown in FIG. 1) may be controlled to transmit or reflect the electromagnetic wave radiated by an antenna by controlling the switch elements (such as the switch elements 120a-10 and 120b-10). However, since the FSS units of the current FSS structure share the same side(s), for example, the FSS unit 120a and the FSS unit 120b of the FSS structure 100 share the same side 130a and the FSS unit 120b and the FSS unit 120c of the FSS structure 100 share the same side 130b, the FSS units of the current FSS structure cannot be controlled independently, which causes that the number of the radiation patterns of the antenna apparatus formed by the current FSS structure is limited.

Based on the above, the present disclosure provides a frequency selective surface structure, an antenna apparatus comprising the FSS structure, and a method for controlling the antenna apparatus. The FSS structure according to embodiments of the present disclosure is composed of multiple FSS units which do not share sides, so that the FSS units of the FSS structure may be controlled independently, which may achieve more radiation patterns of the antenna apparatus formed by the FSS structure.

The FSS structure according to embodiments of the present disclosure may comprise at least two FSS units. Each FSS unit may comprise a substrate, a first metal sheet (such as a patch which may be a circular, a square and the like) and a second metal sheet (such as a ring, e.g., circular ring or a square ring). The second metal sheet surrounds the first metal sheet with a gap therebetween, and at least one switch element is provided on the second metal sheet. Substrates of the at least two FSS units are in contact with each other. For example, the substrates of the at least two FSS units may be or form a single large substrate on which the first metal sheets and the second metal sheets of respective FSS units are provided. The second metal sheets of the at least two FSS units are not in contact with each other, so that each FSS unit may be controlled independently. The distance between the respective second metal sheets may be set based on the materials, size and the like of the substrate, the first metal sheet and the second metal sheet, the electromagnetic wave to be radiated or received, and/or the radiation pattern requirements. For example, the distance between the respective second metal sheets may be less than one wavelength in free space of the electromagnetic wave to be radiated or received, which may facilitate a better radiation pattern.

The FSS unit is in the on state when all switch elements of the FSS unit are in the on state, and the FSS unit is in the off state when all switch elements of the FSS unit are in the off state. The on or off state of each FSS unit may be indicated by a bit, and thus a state (i.e., operation state) of the FSS structure may be indicated by a binary sequence. Each bit of this binary sequence corresponds to a corresponding FSS unit of the FSS structure. When the FSS structure forms an antenna apparatus together an antenna, this binary sequence may also be used as a control signal for controlling the FSS structure and/or indicate the radiation pattern of the antenna apparatus, which may cause the control and indication of the radiation pattern of the antenna apparatus to be simple.

An inductor and a capacitor may be connected in parallel at both ends of each switch element of the FSS unit and may be configured for adjusting and matching of the FSS unit. A control circuit may be applied on the FSS unit, and all switch elements of one FSS unit may be controlled by a bias circuit of the control circuit.

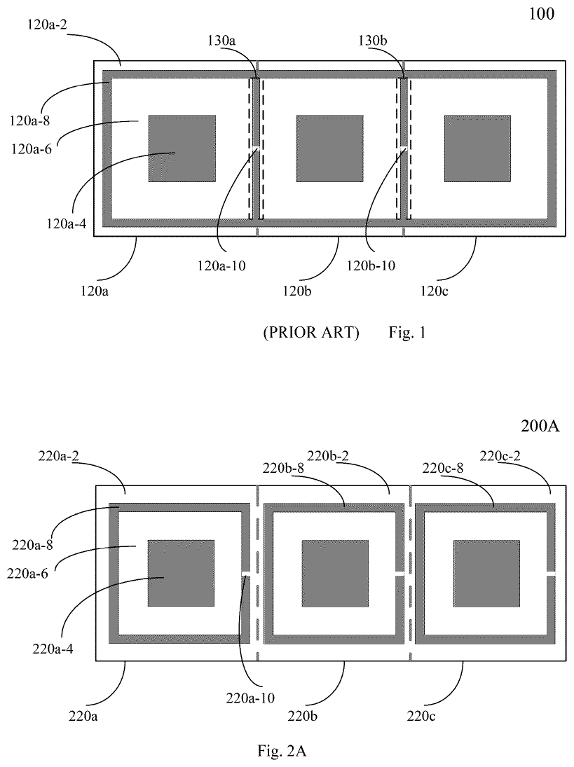

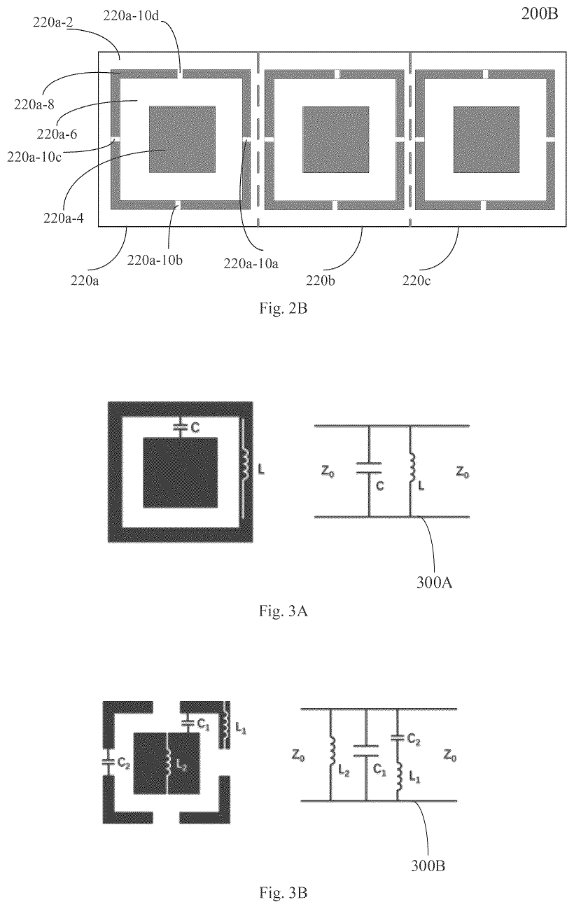

FIGS. 2A and 2B show examples of the FSS structure according to an embodiment of the present disclosure. The FSS structure 200A shown in FIG. 2A may comprise three FSS units 220a, 220b, and 220c. For example, the FSS unit 220a may comprise a substrate 220a-2, a first metal sheet 220a-4 and a second metal sheet 220a-8. The second metal sheet 220a-8 surrounds the first metal sheet 220a-4 with a gap 220a-6 therebetween, and one switch element 220a-10 is provided on the second metal sheet 220a-8. In the example of FIG. 2A, the substrate 220a-2 is a part of a single large substrate. That is, in the example of FIG. 2A, the FSS units 220a, 220b, and 220c are formed by providing first and second metal sheets on a single large substrate.

The FSS unit 220a may be controlled to transmit or reflect the electromagnetic wave by controlling the switch element 220a-10 to be on or off. For example, if the switch element 220a-10 is on, the FSS unit 220a is on and may transmit the electromagnetic wave, and if the switch element 220a-10 is off, the FSS unit 220a is off and may reflect the electromagnetic wave. The FSS unit 220b and 220c have the same structure as the FSS unit 220a. As shown in FIG. 2A, the second metal sheets 220a-8, 220b-8 and 220c-8 of the FSS units 220a, 220b and 220c are not in contact with each other. Note, in this disclosure, the FSS units have the same structure does not require that these FSS units are exactly identical to each other. It is possible that there is a difference among the FSS units (e.g., caused by the industrial manufacturing accuracy), as long as this difference does not result in substantially different transmission and/or reflection characteristics of the FSS units.

In this disclosure, the substrate (such as substrates 220a-2, 220b-2 and 220c-2 shown in FIG. 2A) of the FSS units may be formed by ceramic materials (such as Al₂O₃, SiO₂ etc.), composite materials (such as glass fiber reinforced epoxy resin (FR-4) or liquid crystal polymer (LCP), etc,) or other suitable materials. The metal forming the first and second metal sheets may be traditional metals (such as copper (Cu), silver (Ag), aluminum (Al), etc.), alloy (such as copper-nickel alloy, silver-palladium alloy, etc.), composite metal materials (such as metal-dielectric multilayer film or metal Mesh, etc.). The first metal sheet and the second metal sheet may be formed by the same or different metal materials. In a case where the first and second metal sheets are formed by the same metal material, exemplarily, the FSS structure may be formed by providing the substrate, depositing the metal material on the substrate to form a metal layer, and etching the metal layer to form the first and second metal sheets. The switch element may be any switch element so that the FSS unit has different characteristics of transmitting or reflecting the electromagnetic wave based on the on or off state of the switch element. For example, the switch element may be a diode (such as a PIN diode), a micro electro mechanical system (MEMS) switch, and a varactor and the like. The materials for the substrate and the first and second metal sheets and the type of the switch element may be selected based on the expected operating frequency band (such as microwave and terahertz), environmental tolerance, and cost requirements.

Since the second metal sheets of the FSS units of the FSS structure according to embodiments of the present disclosure are not in contact with each other, the FSS units of the FSS structure may be controlled independently, which may achieve more radiation patterns of the antenna apparatus formed by the FSS structure.

When at least two switch elements are provided on the second metal sheet, at least two switch elements may be provided on the second metal sheet evenly. For example, in a case where the second metal sheet is square and the four switch elements are provided on the second metal sheet, the four switch elements may be provided at midpoints of four sides of the second metal sheet. FIG. 2B shows this example. As shown in FIG. 2B, four switch elements 220a-10a, 220a-10b, 220a-10c and 220a-10d of the FSS unit 220a may be provided at midpoints of four sides of the second metal sheet 220a-8.

FIGS. 3A and 3B show example equivalent circuit diagrams of the FSS unit of the FSS structure 200B shown in FIG. 2B. Specifically, FIG. 3A shows example equivalent circuit diagram 300A of the FSS unit (such as FSS unit 220a) shown in FIG. 2B, when all switch elements of the FSS unit are in on state and the electromagnetic wave is vertically incident on the FSS unit. The equivalent circuit diagram 300A may comprise a capacitance C and an inductance L, and has the same characteristic impedance Z₀ regardless a signal is input from the left side or the right side of the equivalent circuit, as shown in FIG. 3A. FIG. 3B shows example equivalent circuit diagram 300B of the FSS unit (such as FSS unit 220a) shown in FIG. 2B, when all switch elements of the FSS unit are in off state and the electromagnetic wave is vertically incident on the FSS unit. The equivalent circuit diagram 300B may comprise capacitances C1 and C2 and inductances L1 and L2, and has the same characteristic impedance Z₀ regardless a signal is input from the left side or the right side of the equivalent circuit, as shown in FIG. 3B.

In this manner (i.e., the switch elements are provided on the second metal sheet evenly), the FSS unit is polarization insensitive, which facilitates the improvement of the radiation pattern of the antenna apparatus formed by the FSS structure comprising such FSS units. Specifically, the antenna polarization is the motion state of the vector endpoint of time-varying electromagnetic field, which is mainly classified into linear polarization, circular polarization and elliptical polarization. When the electromagnetic wave with arbitrary polarization mode is vertically incident on the FSS unit with evenly provided switch elements, the incident electromagnetic wave may be decomposed into two linearly polarized components perpendicular to each other along a plane where the FSS unit is located. Since the geometric characteristic of the FSS unit is completely the same for these two components, when the switch elements of the FSS unit are all on, the equivalent circuit of the FSS unit is shown in FIG. 3A regardless of whether the electric field of the electromagnetic wave is along the X axis or the Y axis, and when the switch elements of the FSS unit are all off, the equivalent circuit of the FSS unit is shown in FIG. 3B regardless of the electric field of the electromagnetic wave along the X axis or the Y axis, which may cause that these two components will get the same reflection and transmission characteristics. Therefore, the filtering characteristics of this FSS unit have nothing to do with the polarization mode of the incident electromagnetic wave.

The FSS structure according to embodiments of the present disclosure may be used in antenna apparatus so that the antenna apparatus has different radiation patterns. The antenna apparatus may comprise an antenna, the FSS structure according to embodiments of the present disclosure, and a control circuit. The antenna may radiate or receive electromagnetic waves in a certain frequency band (such as 2.4G band (2.405 GHz-2.485 GHz), 5G band (5.15 GHz~5.85 GHz), 5.5G band (3.3 GHz-7.125 GHz and 24 GHz-100 GHz) and the like). The control circuit may be configured to control the switch element(s) of the FSS units of the FSS structure to be on or off (and control other operations of the antenna apparatus). The antenna and the FSS structure may be inserted into a floor (such as a printed circuit board (PCB) floor). The FSS structure may be arranged around the antenna so that the antenna apparatus has different radiation patterns when respective FSS units of the FSS structure are in different on/off states. Exemplarily, a distance between the antenna and the FSS structure may be larger than a quarter wavelength of an electromagnetic wave emitted by the antenna, which may cause the FSS structure to switch between transmission and reflection of the electromagnetic wave radiated by the antenna with a small distance limitation between the antenna and the FSS structure and a small limitation of the antenna form.

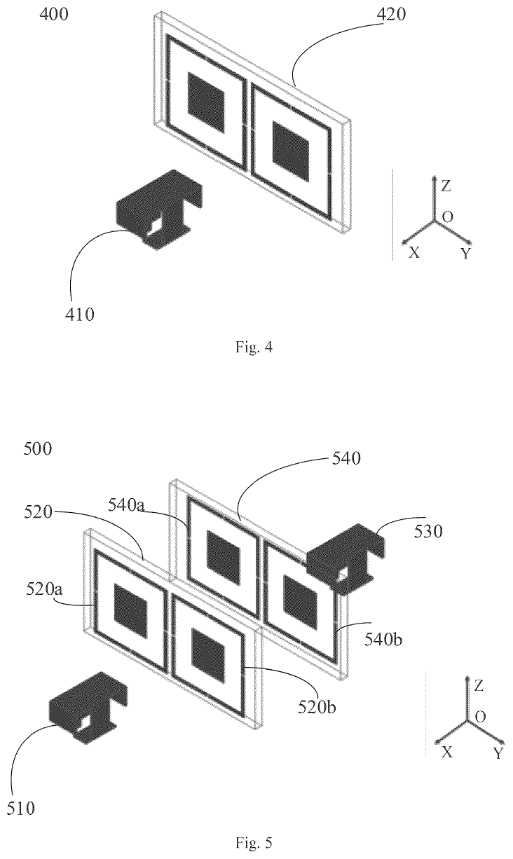

In an embodiment, the FSS structure of the antenna apparatus may be a plane structure (that is, the shape of the FSS structure is a plane) and located at one side of the antenna in a manner of the FSS structure being vertical to a plane on which the antenna is located. FIG. 4 shows such an antenna apparatus.

The antenna apparatus 400 shown in FIG. 4 may comprise an antenna 410 and an FSS structure 420, which is a plane structure. The FSS structure 420 may be located at one side of the antenna 410, and the FSS structure 420 is vertical to a plane on which the antenna 410 is located (i.e., the plane XOY shown in FIG. 4).

In this case, if the antenna (e.g., the antenna 410) is an omnidirectional antenna, the FSS structure (e.g., the FSS structure 420) may be located at any side of the antenna. If the antenna is a directional antenna, the FSS structure may be located at the side of the antenna to which the radiation direction of the antenna is directed.

In another embodiment, the antenna apparatus may comprise two antennas components (i.e., a first antenna component and a second antenna component) and two FSS substructures (i.e., a first FSS substructure and a second FSS substructure). The first antenna component and the second antenna component may be the same antenna (e.g., the same type of antenna), for example, radiating or receiving the electromagnetic wave in the same frequency band, and having the same radiation characteristic (e.g., both omnidirectional antenna). The first FSS substructure and the second FSS substructure may be the same FSS structure, for example, having the same number of FSS units and the same shape.

The antenna and the FSS structure may be arranged in a mirror image manner. For example, the first antenna component and the first FSS substructure may be arranged in mirror image with respect to the second antenna component and the second FSS substructure, the first and second antenna components are located between the first and second FSS substructures, and the first and second FSS substructures are vertical to a plane on which the first and second antennas are located. Alternatively, the first antenna component and the first FSS substructure may be arranged in mirror image with respect to the second antenna component and the second FSS substructure, the first and second FSS substructures are located between the first and second antenna components, and the first and second FSS substructures are vertical to a plane on which the first and second antennas are located. FIG. 5 shows such an antenna apparatus. The antenna apparatus in which the antennas and the FSS structures are arranged in a mirror image manner may achieve better pattern performance with fewer FSS units.

The antenna apparatus 500 shown in FIG. 5 may comprise a first antenna component 510, a first FSS substructure 520, a second antenna component 530, and a second FSS substructure 540. The first antenna component 510 and the second antenna component 530 may be the same type of antenna. The first FSS substructure 520 and the second FSS substructure 540 may be the same FSS structure. In the example of FIG. 5, the first FSS substructure 520 has two FSS units 520a and 520b, and the second FSS substructure 540 has two FSS units 540a and 540b. The FSS unit shown in FIG. 5 may be the FSS unit shown in FIG. 2B. The antenna and the FSS structure are arranged in a sequence of the first antenna component 510, the first FSS substructure 520, the second FSS substructure 540, and the second antenna component 530 in a mirror image manner, and the first FSS substructure 520 and second FSS substructure 540 are vertical to a plane on which the antenna components 510 and 530 are located (i.e., the plane XOY shown in FIG. 5), as shown in FIG. 5.

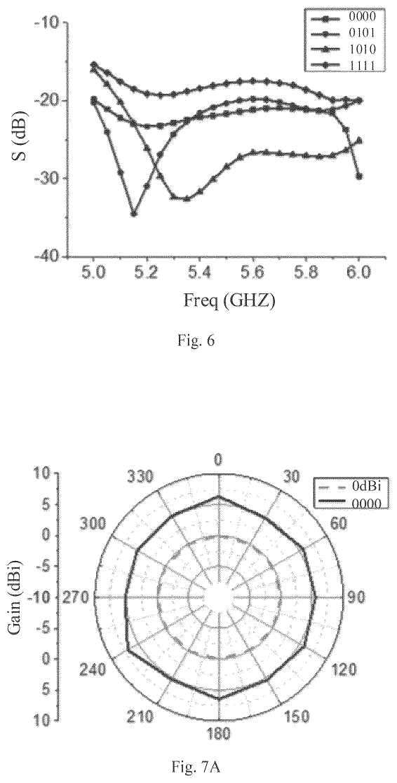

FIG. 6 shows an example reflection coefficient of the antenna apparatus 500 shown in FIG. 5 under different operation states of the FSS structure thereof. In the example of FIG. 6, the following assumptions are made. For the FSS structure (i.e., the first FSS substructure 520 and the second FSS substructure 540) of the antenna apparatus 500, its operation state is indicated by a binary sequence of 4 bits. Each bit may be used to indicate the on/off state of the corresponding FSS unit. The first bit may indicate on/off state of the FSS unit 520a, the second bit may indicate on/off state of the FSS unit 520b, the third bit may indicate on/off state of the FSS unit 540a, and the fourth bit may indicate on/off state of the FSS unit 540b. The antenna components 510 and 530 are omnidirectional antenna and may radiate electromagnetic waves in the WIFI 5G band. When the corresponding FSS unit is in the on state, the electromagnetic wave radiated by the antenna (i.e., the antenna components 510 and 530) may transit through the FSS unit, and when the corresponding FSS unit is in the off state, the electromagnetic wave radiated by the antenna may be reflected by the FSS unit. The value 1 of the bit may indicate the on state of the corresponding FSS unit, and the value 0 of the bit may indicate the off state of the corresponding FSS unit. That is, FIG. 6 shows four operation states of the FSS structure. “0000” indicates FSS units 520a, 520b, 540a and 540a are all off. “0101” indicates FSS units 520a and 540a are off, and FSS units 520b and 540b are on. “1010” indicates FSS units 520a and 540a are on, and FSS units 520b and 540b are off. “1111” indicates FSS units 520a, 520b, 540a and 540a are all on.

As shown in FIG. 6, under four operation states of the FSS structure, the reflection coefficients of the antenna apparatus 500 in the WIFI 5G band are all smaller than −10 dB, which meets the basic design requirements of the antenna apparatus.

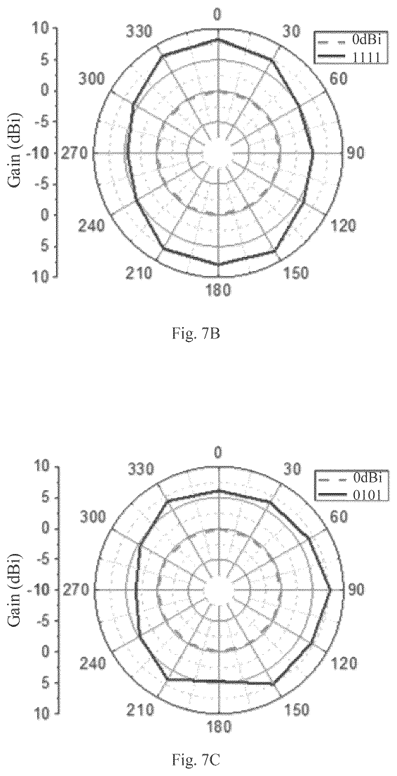

FIGS. 7A-7D show example radiation patterns of the antenna apparatus 500 shown in FIG. 5. The example radiation patterns shown in FIGS. 7A-7D are radiation patterns of the antenna apparatus 500 (i.e., the synthetic radiation pattern of the antenna components 510 and 530) on the plane with an evelation of 30° (i.e., the included angle between the plane of radiation pattern and the plane XOY shown in FIG. 5 is 30°).

In the example of FIGS. 7A-7D, all assumptions are the same as those made in the example of FIG. 6, except that the antenna components 510 and 530 radiate electromagnetic waves in WIFI 5.5G band.

From FIGS. 7A-7D, in one example, it may be seen that when the operation state “1111” of the FSS structure, the radiation pattern is a complementary omnidirectional radiation with good omnidirectional. When the operation state is “0000”, the maximum radiation direction is φ=180° where φ is the included angle between the plane of the radiation pattern and the plane XOZ shown in FIG. 30. When the operation state is “0101”, the main radiation direction is along the positive direction of the Y axis shown in FIG. 5. When the operation state is “1010”, the main radiation direction is along the negative direction of the Y axis shown in FIG. 5. In addition, it may be seen that the antenna apparatus 500 shown in FIG. 5 at least may switch among one omnidirectional radiation pattern and three directional radiation patterns on the plane with a low evelation, and thus the communication coverage is wide. In four operation states of the FSS structure, the gains of the antenna apparatus 500 are all greater than 0 dBi on the plane with a low evelation, which meets the communication requirements in the required direction and ensures good omnidirectional radiation.

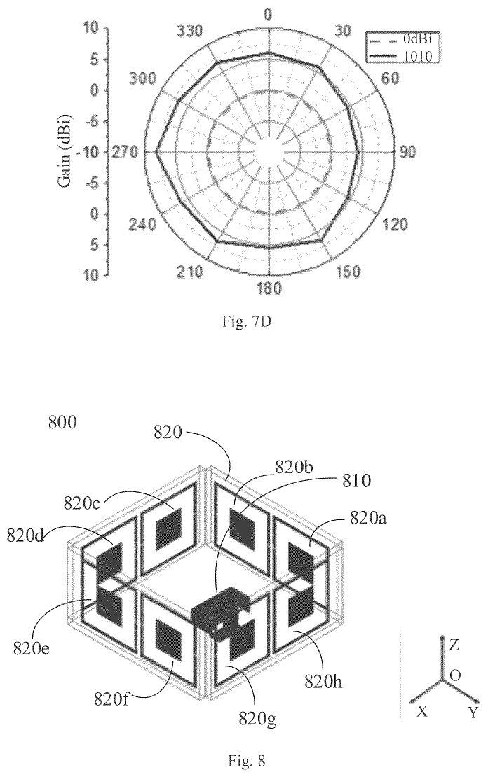

In yet another embodiment, the antenna apparatus may comprise an antenna and an FSS structure. The FSS structure of the antenna apparatus may surround the antenna apparatus. For example, the antenna is at the center of the FSS structure. The FSS structure may be cylindrical or polyhedral (e.g., tetrahedron) with or without a cover. In a case where the FSS structure is cylindrical without a cover, the projection of the FSS structure on the plane on which the antenna is located is circular. In a case where the FSS structure is tetrahedron without a cover, the projection of the FSS structure on the plane on which the antenna is located may be a square. In this case, the FSS structure may comprise a plurality of FSS units in a multiple of four (such as 8, 12 and the like.) FIG. 8 shows an example of such an antenna apparatus in which the FSS structure is a tetrahedron without a cover.

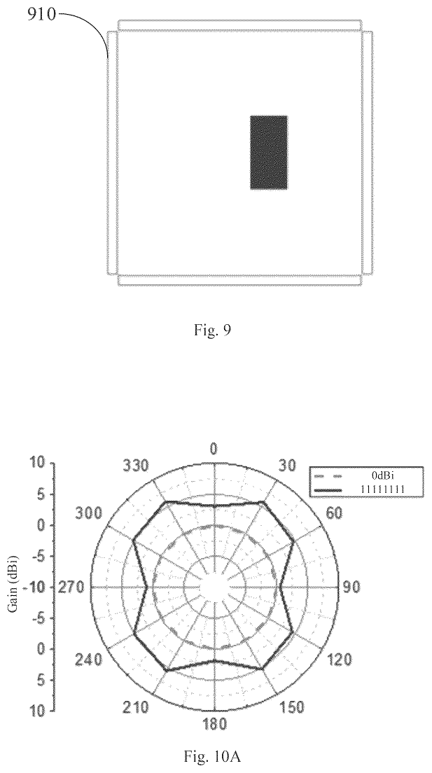

The antenna apparatus 800 shown in FIG. 8 may comprise an antenna 810 and an FSS structure 820. The FSS structure 820 comprises 8 FSS units 820a to 820h. The FSS structure 820 surrounds the antenna 810, and the projection of the FSS structure 820 on the plane on which the antenna is located 810 may be a square, as shown 910 in FIG. 9.

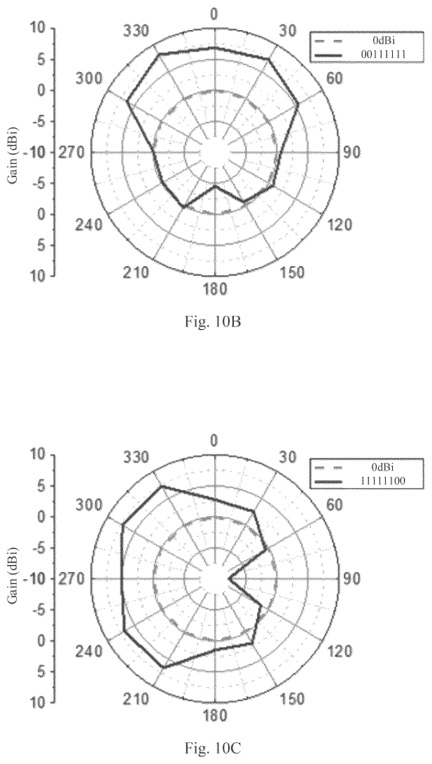

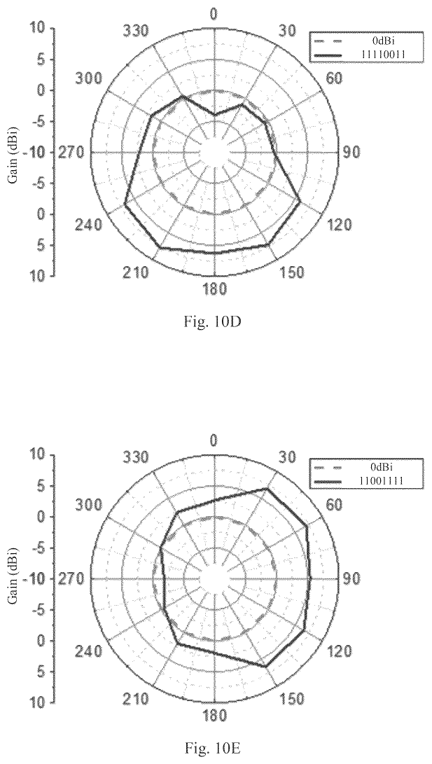

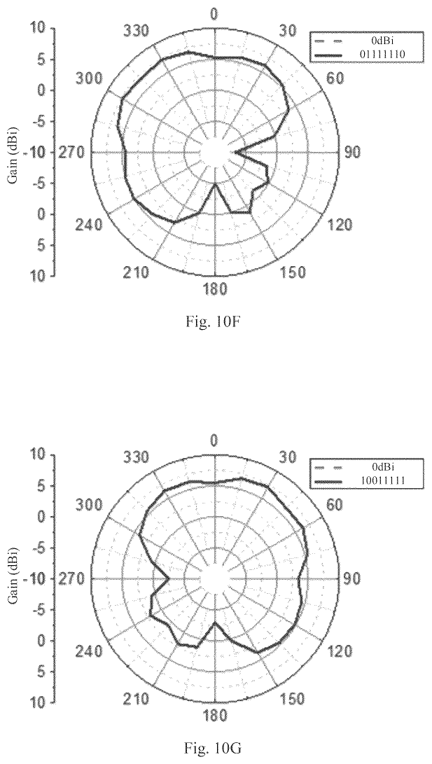

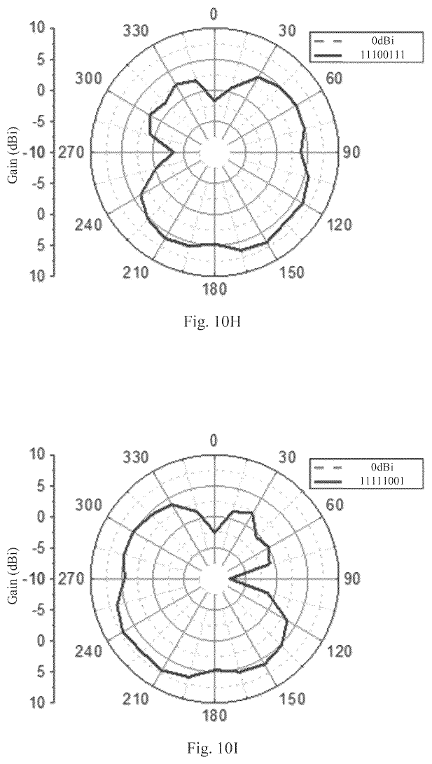

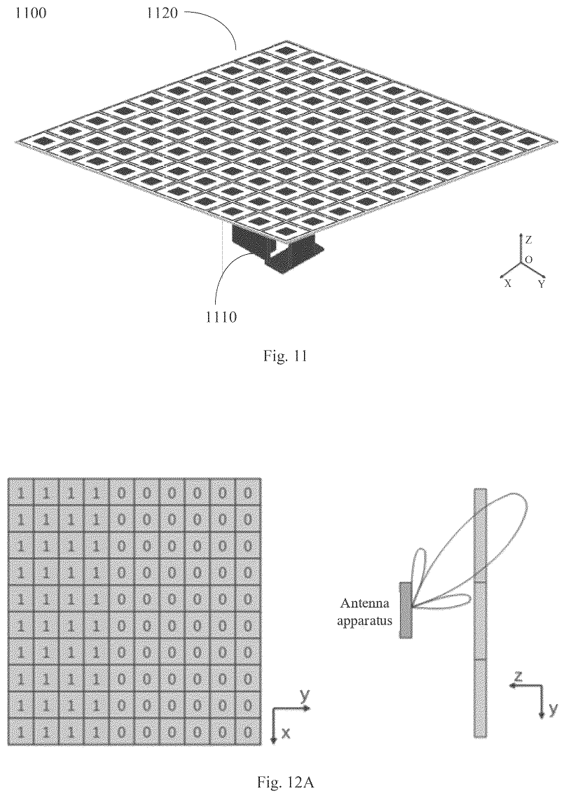

FIGS. 10A-10I show example radiation patterns of the antenna apparatus 800 shown in FIG. 8. The example radiation pattern shown in FIGS. 10A-10I is the radiation pattern of the antenna apparatus 800 on the plane with and evelation of 30°. In the example of FIGS. 10A-10I, the same assumptions as those in FIGS. 7A-7D are made, except that a binary sequence of 8 bits are used to indicate the operation state of the FSS structure 820, in which the first bit to the eighth bit corresponds to the FSS unit 820a-820h, respectively.

In the example of FIGS. 10A-10I, the antenna apparatus 910 shown in FIG. 9 may switch among one omnidirectional pattern shown in FIG. 10A and eight directional patterns shown in FIGS. 10B-10I on the plane with a low evelation.

In yet another embodiment, the antenna apparatus may comprise an antenna and an FSS structure. The FSS structure may be a plane structure and is located above the antenna; that is, the FSS structure is parallel to a plane on which the antenna is located. Exemplarily, the FSS structure may be located right above the antenna. This arrangement of the antenna and the FSS structure may be achieved by a support member on the floor into which the antenna is inserted, supporting the FSS structure. The FSS structure may be circular, rectangular, or other shapes, which are not limited herein. FIG. 11 shows an example of such an antenna apparatus in which the FSS structure is a square.

The antenna apparatus 1100 shown in FIG. 11 may comprise an antenna 1110 and an FSS structure 1120. The FSS structure 1120 is a square formed by 100 FSS units. The FSS structure 1120 is located right above the antenna 1110.

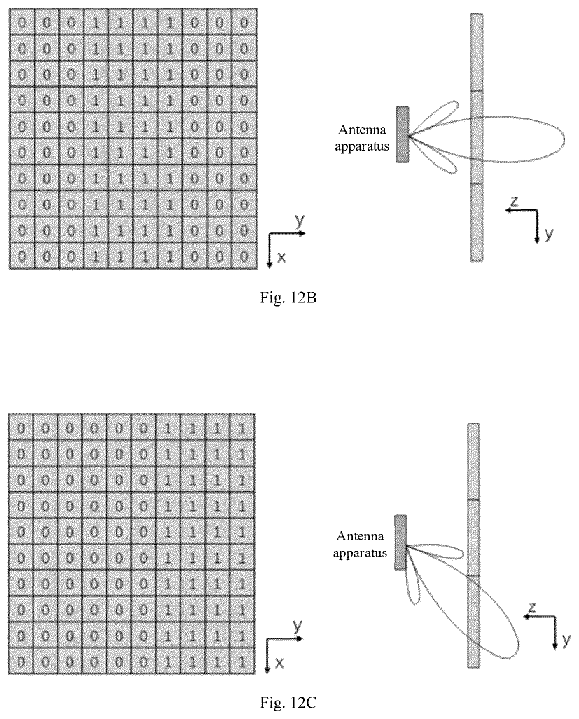

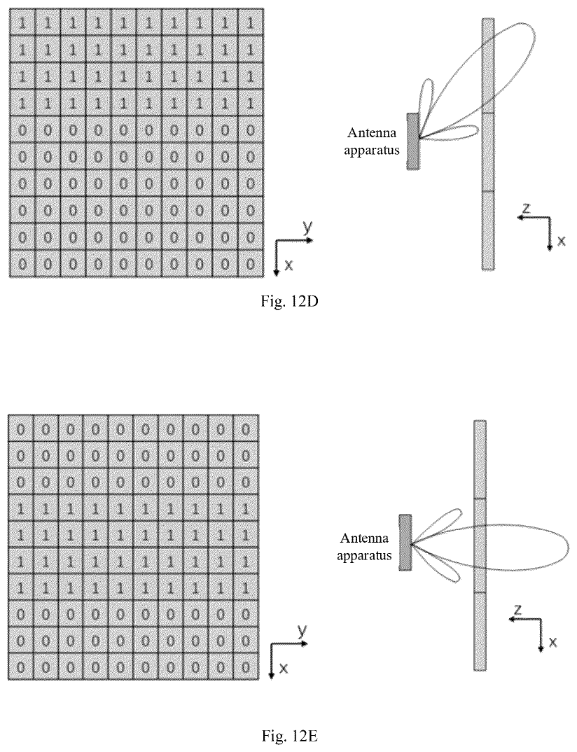

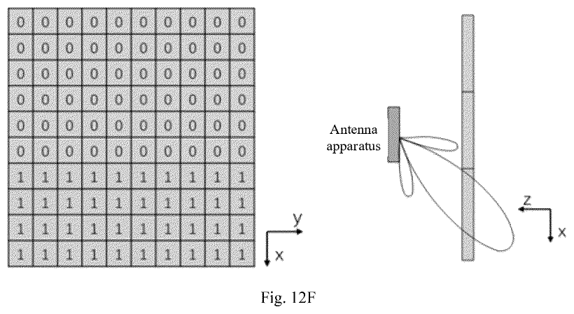

FIGS. 12A-12F show example radiation patterns of the antenna apparatus shown in FIG. 11. The example radiation pattern shown in FIGS. 12A-12F is the radiation pattern of the antenna apparatus 1100 on the plane with an evelation of 30°. In the example of FIGS. 12A-12F, the same assumptions as those in FIGS. 7A-7D are made, except that a binary array of 100 bits shown in FIGS. 12A-12F is used to indicate the operation state of the FSS structure 1120. In this case, the bit array shown in FIGS. 12A-12F may be seen as a special binary sequence. The directions of the X, Y and Z axis shown in FIGS. 12A-12F correspond to the directions of the X, Y and Z axis shown in FIG. 11, respectively.

As shown in FIGS. 12A-12F, the antenna apparatus 1100 shown in FIG. 11 may switch among multiple radiation patterns with good direction.

In addition, the present disclosure further provides a method for controlling the antenna apparatus described above. The method may comprise controlling the at least one switch element of each FSS unit of the FSS structure to be on or off based on a control signal, so as to control the radiation pattern of the antenna apparatus.

So far, the present disclosure has disclosed an FSS structure, the antenna apparatus, a method for controlling the antenna apparatus. The FSS units of the FSS structure according to embodiments of the present disclosure are not in contact with each other, so that the FSS units of the FSS structure may be controlled independently, which may achieve more radiation patterns of the antenna apparatus formed by the FSS structure. In addition, when at least two switch elements are provided on the FSS structure, at least two switch elements may be provided on the second metal sheet evenly, which may cause the FSS unit to be polarization insensitive, thereby facilitating the improvement of the radiation pattern of the antenna apparatus formed by the FSS structure comprising such FSS units.

It should be noted that the above description is only some embodiments of the present disclosure and an illustration of the applied technical principles. It should be understood by those skilled in the art that the present disclosure scope involved in the present disclosure is not limited to the technical solutions resulted from specific combinations of the above technical features, but also encompasses other technical solutions resulted from any combination of the above technical features or their equivalents without departing from the above disclosed concept, for example, the technical solutions formed by replacing between the above features and the technical features with similar functions disclosed in the present disclosure (but not limited thereto).

In addition, although the operations are depicted in a specific order, this should not be understood as requiring these operations to be performed in the specific order shown or in a sequential order. In certain circumstances, multitasking and parallel processing may be beneficial. Likewise, although several specific implementation details are included in the above discussion, these should not be interpreted as limiting the scope of the present disclosure. Some features described in the context of separate embodiments may also be implemented in a single embodiment in combination. On the contrary, various features described in the context of a single embodiment may also be implemented in multiple embodiments alone or in any suitable sub-combination.

Although the subject matter has been described in a language specific to structural features and/or logical acts of methods, it should be understood that the subject matter defined in the appended claims is not necessarily limited to the specific features or acts described above. On the contrary, the specific features and actions described above are merely example forms of implementing the claims.

What is claimed is:

1. A frequency selective surface (FSS) structure comprising:
at least two FSS units, wherein each FSS unit comprises a substrate, a first metal sheet and a second metal sheet, the second metal sheet surrounding the first metal sheet with a gap therebetween,
wherein substrates of the at least two FSS units are in contact with each other, wherein at least one switch element is provided on the second metal sheet, and wherein the second metal sheets of the at least two FSS units are not in contact with each other.

2. The FSS structure of claim 1, wherein at least two switch elements are provided on the second metal sheet evenly.

3. The FSS structure of claim 2, wherein the second metal sheet is square, and wherein four switch elements are provided at midpoints of four sides of the second metal sheet.

4. The FSS structure of claim 1, wherein for each FSS unit, an electromagnetic wave transits through the FSS unit when all switch elements of the FSS unit are in on state, and the electromagnetic wave is reflected by the FSS unit when the all switch elements of the FSS unit are in off state.

5. The FSS structure of claim 1,
wherein, for each FSS unit, the FSS unit is in on state when all switch elements of the FSS unit are in on state, and the FSS unit is in off state when all switch elements of the FSS are in off state; and
wherein an on or off state of each FSS unit is indicated by a bit, and a state of the FSS structure is indicated by a binary sequence, wherein each bit of the binary sequence corresponds to a corresponding FSS unit of the FSS structure.

6. An antenna apparatus comprising,
an antenna, and
a frequency selective surface (FSS) structure,
wherein the FSS structure comprises at least two FSS units, wherein each FSS unit comprises a substrate, a first metal sheet and a second metal sheet, the second metal sheet surrounding the first metal sheet with a gap therebetween, wherein substrates of the at least two FSS units are in contact with each other, wherein at least one switch element is provided on the second metal sheet, and wherein the second metal sheets of the at least two FSS units are not in contact with each other; and
a control circuit, configured to control the at least one switch element of each FSS unit to be on or off based on a control signal.

7. The antenna apparatus of claim 6, wherein at least two switch elements are provided on the second metal sheet evenly.

8. The antenna apparatus of claim 7, wherein the second metal sheet is square, and wherein four switch elements are provided at midpoints of four sides of the second metal sheet.

9. The antenna apparatus of claim 6, wherein for each FSS unit, an electromagnetic wave transits through the FSS unit when all switch elements of the FSS unit are in on state, and the electromagnetic wave is reflected by the FSS unit when the all switch elements of the FSS unit are in off state.

10. The antenna apparatus of claim 6,
wherein for each FSS unit, the FSS unit is in on state when all switch elements of the FSS unit are in on state, and the FSS unit is in off state when all switch elements of the FSS are in off state; and
wherein an on or off state of each FSS unit is indicated by a bit, and a state of the FSS structure is indicated by a binary sequence, wherein each bit of the binary sequence corresponds to a corresponding FSS unit of the FSS structure.

11. The antenna apparatus of claim 6,
wherein the FSS structure is a plane structure, and
wherein the FSS structure is located at one side of the antenna, the FSS structure being vertical to a plane on which the antenna is located.

12. The antenna apparatus of claim 6,
wherein the antenna comprises a first antenna component and a second antenna component, and the FSS structure comprises a first FSS substructure and a second FSS substructure which are same plane structures, and
wherein the first antenna component and the first FSS substructure are arranged in a mirror image with respect to the second antenna component and the second FSS substructure, wherein the first and second FSS substructures are located between the first and second antenna components and are vertical to a plane on which the first and second antennas components are located.

13. The antenna apparatus of claim 6, wherein the FSS structure surrounds the antenna.

14. The antenna apparatus of claim 13, wherein the FSS structure comprises a plurality of FSS units in a multiple of four, and wherein a projection of the FSS structure on a plane on which the antenna is located is square.

15. The antenna apparatus of claim 6, wherein the FSS structure is a plane structure and is located above the antenna.

16. The antenna apparatus of claim 15, wherein the FSS structure is square, and wherein the FSS structure is located right above the antenna.

17. The antenna apparatus of claim 6, wherein a distance between the antenna and the FSS structure is larger than a quarter wavelength of an electromagnetic wave emitted by the antenna.

18. A method for controlling an antenna apparatus comprising an antenna, a FSS structure, and a control circuit, wherein the FSS structure comprises at least two FSS units, wherein the method comprising:
controlling at least one switch element of each FSS unit to be on or off based on a control signal,
wherein each FSS unit comprises a substrate, a first metal sheet and a second metal sheet, the second metal sheet surrounding the first metal sheet with a gap therebetween, wherein substrates of the at least two FSS units are in contact with each other, wherein the at least one switch element is located on the second metal sheet, and wherein the second metal sheets of the at least two FSS units are not in contact with each other.

19. The method of claim 18, wherein at least two switch elements are provided on the second metal sheet evenly.

20. The method of claim 18,
wherein the antenna comprises a first antenna component and a second antenna component, and the FSS structure comprises a first FSS substructure and a second FSS substructure which are same plane structures, and
wherein the first antenna component and the first FSS substructure are arranged in a mirror image with respect to the second antenna component and the second FSS substructure, wherein the first and second FSS substructures are located between the first and second antenna components and are vertical to a plane on which the first and second antennas components are located.
